(19) United States
(12) Patent Application Publication
(10) Pub. No.: US 2009/0313651 A1
(43) Pub. Date: Dec. 17, 2009

(54) Electronic Apparatus Having Operation Restriction Function

(75) Inventor: Yasuyuki IKEGUCHI, Hyogo (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/486,441

(22) Filed: Jun. 17, 2009

(30) Foreign Application Priority Data
Jun. 17, 2008 (JP) 2008-157467

(51) Int. Cl. H04N 7/16

(52) U.S. Cl. 725/30

(57) ABSTRACT

The first unlock code is composed of a number “m” of characters, all of which belong to a predetermined category. The second unlock code is composed of a number other than the number “m” of characters, or composed of characters at least one of which does not belong to the predetermined category.

This nonprovisional application claims priority under 35 U.S.C. § 119(a) on Patent Application No. 2008-157467 filed in Japan on Jun. 17, 2008, the entire contents of which are hereby incorporated by reference.

### BACKGROUND OF THE INVENTION

1. Field of the Invention

The present invention relates to an electronic apparatus having an operation restriction function for preventing theft and the like.

2. Description of Related Art

Conventionally, in stores selling electronic apparatuses such as television broadcast receivers, electronic apparatuses are often displayed in the stores, for example, for customers to see. This, however, tends to invite theft of electronic apparatuses (products), and countermeasures have been taken to prevent this.

One such countermeasure is to previously register an unlock code with an electronic apparatus and permit the electronic apparatus to operate normally only when the unlock code is entered (that is, to restrict the operation of the electronic apparatus). For example, in a case in which the electronic apparatus is a television broadcast receiver, video display and sound output may be restricted.

In this way, a stolen electronic apparatus cannot be properly used unless an authorized unlock code is entered. This helps discourage a person from stealing (in a case, for example, in which the person intends to steal an electronic apparatus for his/her personal use), and thus theft can be effectively prevented thereby. Incidentally, it is possible to appropriately deal with a rightful purchaser who has rightfully purchased an electronic apparatus by telling him/her the authorized unlock code when payment is completed.

Typically, each electronic apparatus is given its own unique unlock code for the purpose of keeping the unlock code secret to achieve enhanced anti-theft effect. As a result, even when the unlock code unique to an electronic apparatus becomes known to someone (a person who has rightfully purchased the electronic apparatus is naturally notified of the unlock code), it is possible to prevent the unlock code from being improperly used to release the operation restriction of other electronic apparatuses.

In the manufacturing process of electronic apparatuses, from the viewpoint of quality control and the like, operation check is performed as necessary with respect to the electronic apparatuses. At this time, it is necessary to temporarily release the operation restriction. However, if each of the electronic apparatuses has its own unique unlock code, the process of releasing the operation restriction will take time and trouble, and this may greatly degrade the manufacturing efficiency.

One possible way to cope with this problem is, in the case of electronic apparatuses manufactured through a common manufacturing process, to set a common unlock code (hereinafter, “common code”) in addition to an unlock code uniquely set for each of the electronic apparatuses (hereinafter, “unique code”). Here, if the operation restriction can be released also by entering the common code, the process of releasing the operation restriction can be simplified.

However, if the common code is leaked to outsiders, it is likely that a person who has obtained one of the electronic apparatus without rightfully purchasing it will release the operation restriction by using the common code. Such a situation will greatly diminish the anti-theft effect achieved by providing the unlock codes. To prevent this, the common code needs to be kept as carefully as possible from leaking to outsiders.

In a case where the common code and the unique code are composed of the same number of characters or composed of characters belonging to the same category (range of characters to be used), there is a fear that the common code may be easily leaked to outsiders. For example, if both the unique and common unlock codes are composed of “seven” characters that belong to the category “the digits 0 to 9” as in “5748534”, it is comparatively easy for a person who knows the unique code of an electronic apparatus to find out the common code by a method such as brute force search.

### SUMMARY OF THE INVENTION

The present invention has been made to solve the problems described above, and an object of the present invention is to provide an electronic apparatus with which a plurality of unlock codes (such as a unique code and a common code as described above) are registered, and that, even if the number of and the category of the characters forming one of the unlock codes have become known, is capable of minimizing the occurrence of a situation in which the other unlock code also becomes known.

To achieve the above object, according to the present invention, an electronic apparatus performing predetermined operation includes: a restriction portion restricting at least part of the predetermined operation; a memory portion storing a first unlock code and a second unlock code that are each composed of one or more characters; an input reception portion receiving input of an input code that is composed of one or more characters; and a restriction release portion comparing the input code with the first or second unlock code and releasing the restriction when the input code is equal to the first or second unlock code. Here, the first unlock code is composed of “m” (a natural number) characters all of which belong to a predetermined category, and the second unlock code is composed of other than “m” characters, or of characters at least one of which does not belong to the predetermined category.

According to this structure, the second unlock code is a code composed of a number other than the number “m” of characters or a code composed of characters at least one of which does not belong to the predetermined category. This makes it possible to minimize the occurrence of a situation in which, when the number and the category of the characters forming one unlock code (first unlock code) become known, the other unlock code (second unlock code) also becomes known.

### BRIEF DESCRIPTION OF THE DRAWINGS

These and other objects and features of the present invention will be understood more clearly from the following descriptions of preferred embodiments and accompanying drawings that are briefly summarized below.

FIG. 1 is a diagram showing the structure of a television broadcast receiver embodying the present invention;

FIG. 2 is a diagram for illustrating the content stored in a first memory

FIG. 3 is a diagram for illustrating the structure of a remote control unit;

FIG. 4 is a diagram for illustrating a code input reception screen;

FIG. 5 is a flow chart for illustrating how operation restriction is performed and released; and

FIG. 6 is a diagram for illustrating the structure of a remote control unit.

### DETAILED DESCRIPTION OF PREFERRED EMBODIMENTS

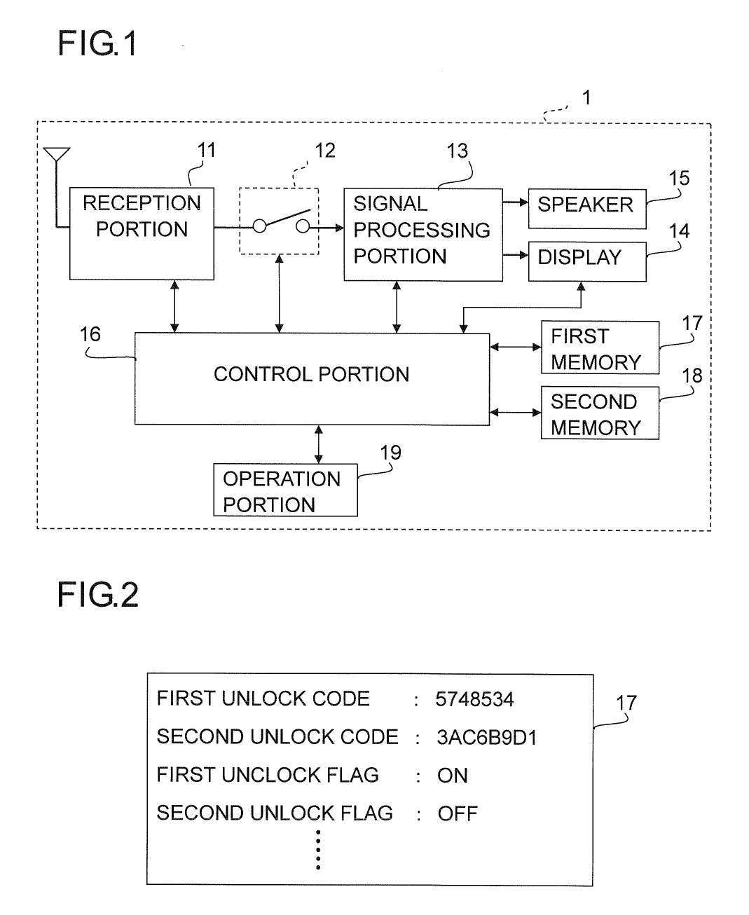

A description will be given of embodiments of the present invention, with a television broadcast receiver (a type of electronic apparatus) taken as an example. Incidentally, the television broadcast receiver can be regarded as an object of, for example, commercial trade, and thus it may hereinafter be referred to as “product”. FIG. 1 is a diagram (block diagram) showing the structure of the television broadcast receiver. As shown in this figure, the television broadcast receiver 1 is provided with a reception portion 11, a connection switch portion 12, a signal processing portion 13, a display 14, a speaker 15, a control portion 16, a first memory 17, a second memory 18, an operation portion 19, and the like.

The reception portion 11 receives a broadcast signal from a television broadcast station via an antenna, a cable, or the like. The reception portion 11 is provided with a tuner function, and extracts a broadcast signal of a previously selected channel and feeds it to the signal processing portion 13 in the succeeding stage succeeding.

The connection switch portion 12 connects or disconnects the reception portion 11 to or from the signal processing portion 13 according to a command of the control portion 16. Thus, the broadcast signal can be transmitted from the reception portion 11 to the signal processing portion 13 when the connection switch portion 12 is in a connecting state in which the reception portion 11 and the signal processing portion 13 are connected to each other, while the broadcast signal cannot be transmitted from the reception portion 11 to the signal processing portion 13 when the connection switch portion 12 is in a disconnecting state in which the reception portion 11 and the signal processing portion 13 are disconnected from each other.

The signal processing portion 13 applies predetermined processing to the broadcast signal transmitted from the reception portion 11 to generate a video signal and an audio signal. Since methods for generating a video signal and an audio signal from a television broadcast signal are well known, no detailed description of any will be given. The generated video and audio signals are transmitted to the display 14 and the speaker 15, respectively.

The display 14 displays video based on the video signal that it has received. The speaker 15 outputs sound based on the audio signal that it has received. Incidentally, the display 14 is also capable of displaying a code input reception screen, which will be described later.

The control portion 16 is formed, for example, with a CPU, and controls various kinds of processing performed in the television broadcast receiver 1. Incidentally, the various kinds of processing includes a series of processing related to performing and releasing operation restriction, which will be described later in detail.

The first memory 17 is formed as a nonvolatile memory which is electrically rewritable, and information can be read therefrom or written thereon by the control portion 16. The first memory 17 stores information necessary for the various kinds of processing performed in the television broadcast receiver 1 as shown in FIG. 2. Now, descriptions will be given of the items shown in FIG. 2.

A first unlock code (unique code) and a second unlock code (common code) are information used for releasing operation restriction which will be described later, and each composed of one or more characters. The first unlock code is supposed to be entered by a rightful purchaser who has rightfully purchased an electronic apparatus (and thus has been notified of the code by an administrator or a shot attendant), and the second unlock code is supposed to be entered basically during the process of operation check in the manufacturing process. When these unlock codes are entered, as will be described later in detail, operation restriction will be released.

The first unlock code is set one for each product as a code unique to each product (that is, different products have different first unlock codes) such that, for example, the first unlock code for a product is “5748534”, that for another product is “3009412”, and that for still another product is “7870522”. The first unlock code is composed of seven digits (which are a kind of character). Here, the first unlock code is composed solely of characters that belong to the category “the digits 0 to 9”.

On the other hand, the second unlock code is set as a code common to all the products of a type that are manufactured through the same manufacturing process (the same process of operation check). The second unlock code is composed of eight characters as in “3AC6B9D1”, and includes alphabetic characters as well as digits as the characters.

Thus, the first and second unlock codes are composed of different numbers of characters. The first unlock code is formed only of characters belonging to the category “the digits 0 to 9”, and in contrast, the second unlock code partly includes alphabetic characters (a kind of character) such as “A” and “B”, which do not belong to the category “the digits 0 to 9”.

A first unlock flag is information indicating whether or not the first unlock code has been entered as an input code. A second unlock flag is information indicating whether or not the second unlock code has been entered as an input code. In whichever unlock flag, “ON” indicates that the corresponding unlock code has been entered, and “OFF” indicates that the corresponding unlock code has not been entered yet.

Here, once the first unlock code is entered, the first unlock flag remains in the “ON” state semipermanently (unless any particularly processing is performed thereon). In contrast, although the second unlock flag remains in the “ON” state for a given period of time (for example, five minutes) after the second unlock code is entered, the second unlock flag then returns to the “OFF” state (that is, the second unlock code is assumed not to have been entered yet).

The second memory 18 is formed as an electrically non-rewritable memory (ROM), from which information can be read out by the control portion 16. The second memory 18 particularly stores fixed information, such as the second unlock code and control program codes, that is part of information necessary for the performance of the various kinds of processing in the television broadcast receiver 1.

Even if the second unlock code stored in the first memory 17 is lost due to, for example, some electric trouble, it can be restored by using the second unlock code stored in the second memory 18. Thus, even if the first and second unlock codes stored in the first memory 17 have been lost, it is possible to urgently restore the second unlock code to avoid a situation in which the operation restriction cannot be released at all.

In the case where such restoration has been carried out, the second unlock code may be notified to a rightful purchaser. In this way, the rightful purchaser can, although temporarily, release the operation restriction by entering the second unlock code. However, since the second unlock code is common to the other products, it is desirable to take measures to prevent the second unlock code from being spread more than necessary.

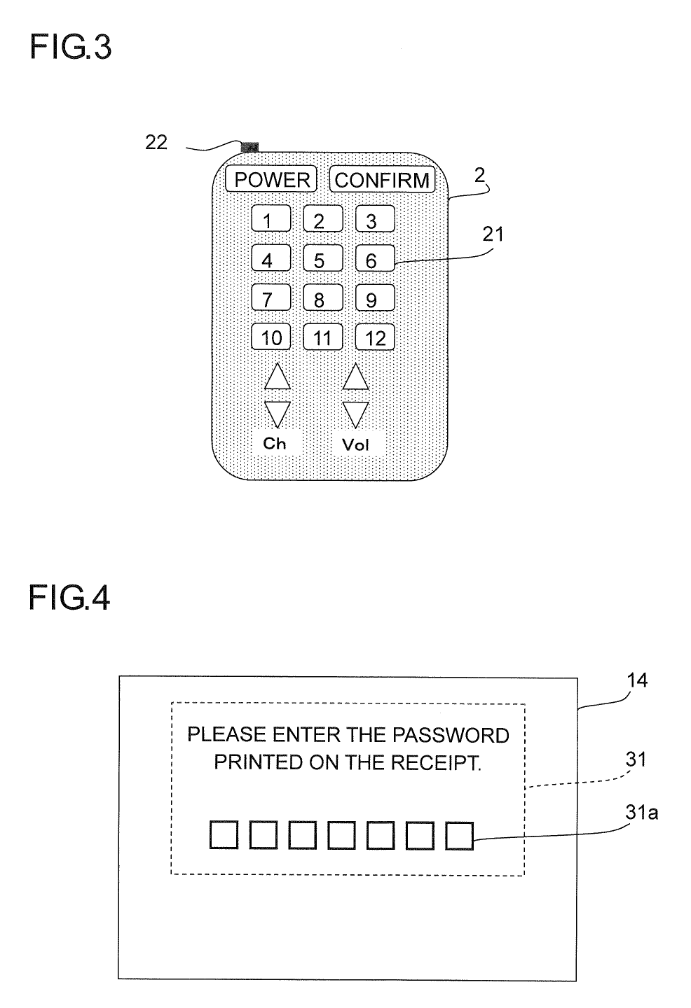

The operation portion 19 is formed as a user interface having switches and the like that are operated by a user. Information on the user's operation here (information indicating the user's intention) is transmitted to the control portion 16 to be reflected in the various kinds of processing. There is no particular limitation with respect to the specific structure of the operation portion 19, but in this embodiment, the operation portion 19 is realized by using a remote (remote control unit) 2 as shown in FIG. 3.

Specifically, the main body of the television broadcast receiver 1 is provided with a remote control signal reception unit, via which is received a remote control signal wirelessly transmitted from a signal transmission portion 22 of the remote 2. The remote 2 is provided with push button switches 21 such as: a “power” button for turning on/off the power supply; a “CONFIRM” button for notifying that an entered content has been confirmed, buttons marked “1” to “12”, respectively, for selecting broadcast channels or numerals, “up” and “down” buttons of “Ch” for broadcast channel selection, and “up” and “down” buttons of “Vol” for turning up and down the volume. When the user presses any of the push button switches 21, a corresponding remote control signal is generated.

With the structure described above, the television broadcast receiver 1, in its normal operation, receives a television broadcast signal, and displays the video and outputs the sound of a program. Furthermore, with the television broadcast receiver 1, it is possible to perform the operation restriction for the purpose of, for example, preventing theft, and moreover, it is also possible to release the operation restriction under a predetermined condition. Next, a description will be given below of the processing of performing and releasing the operation restriction with reference to the flow chart shown in FIG. 5.

When the power supply is turned from an OFF state to an ON state, it is judged whether or not the first or second unlock flag stored in the first memory 17 is ON (step S1). When both of the flags are judged to be OFF (“N” in step S1), the connection switch portion 12 is brought into the disconnecting state. In this state, no broadcast signal is transmitted to the stage succeeding the reception portion 11, and thus no video is displayed on the display 14 and no sound is outputted from the speaker 15 (step S2). That is, operation of the television broadcast receiver 1 such as various kinds of processing of a broadcast signal, video display, and sound output that should be performed in the normal operation is restricted.

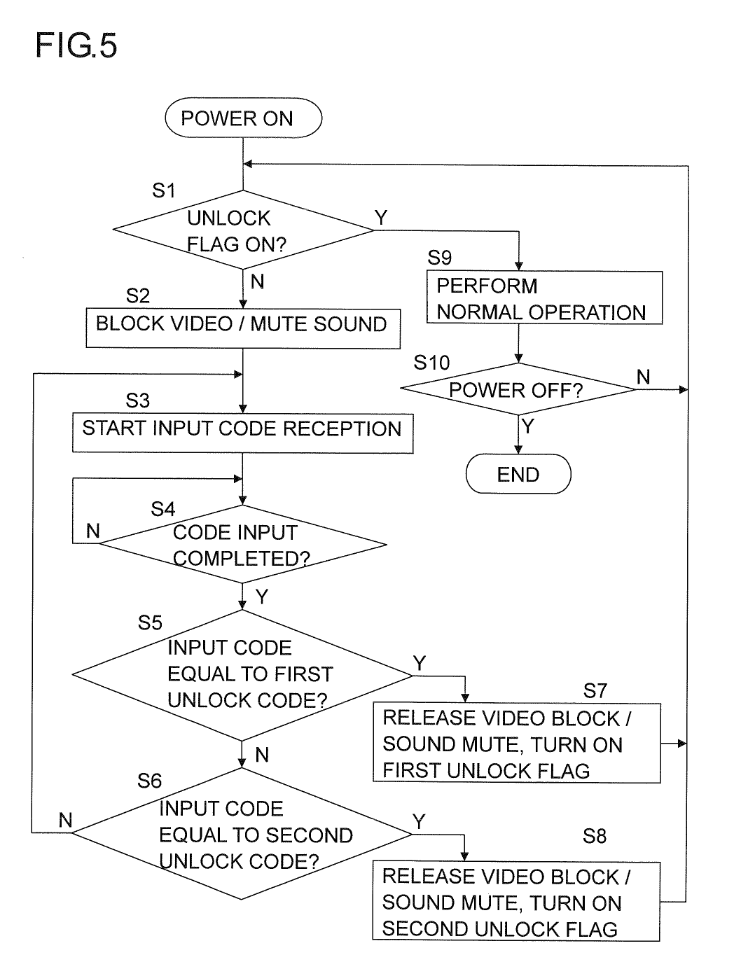

Thereafter, the control portion 16 starts to receive code input by, for example, a user (step S3). Specifically, the control portion 16 first makes the display 14 display a code input reception screen 31 as shown in FIG. 4. The code input reception screen 31 invites the user to enter a code (input code), and as can be seen from the fact that there is provided an input space 31a that is just enough for seven characters, the user is invited to enter seven characters as a code.

When one or more characters are entered in order, a code is recognized to be entered starting with its first character in that order. Then, a character or a special character such as “” is displayed in the input space 31a in response to each input. Thus, the user can see and check if the input of each character has been received.

As for how to enter the characters, each time one of the buttons “1” to “10” is pressed, the digit on the button is entered (note that the digit “0” is entered when the button “10” is pressed). When the “up” and “down” buttons of “Ch” and the “up” and “down” buttons of “Vol” are pressed, “A”, “B”, “C”, and “D” are entered, respectively.

This means that pressed in the case where the second unlock code is entered as the input code are the “up” and “down” buttons of “Ch” and those of “Vol”, which are not pressed in entering the first unlock code. Although the code input reception screen 31 invites the user to enter a code composed of seven characters, but in practice, it is possible to enter a code of eight characters by entering one more character after the seventh character is entered. Since input of a seven-character code is invited, it is difficult for a person who does not know the second unlock code to realize that the second unlock code is composed of eight (or any number other than seven of) characters.

When the “CONFIRM” button in the remote control 2 is pressed after all the characters forming the code are entered in the above described manner, the control portion 16 judges the input of the code to have been completed (“Y” in step S4), and regards what has been entered as the input code. Thereafter, the control portion 16 judges whether or not the input code is equal to the first unlock code (step S5).

When the input code is judged to be equal to the first unlock code (“Y” in step S5), the connection switch portion 12 is switched to the connecting state. As a result, a broadcast signal is transmitted to the stage succeeding the reception portion 11, and operation such as various kinds of processing of the broadcast signal, video display, and sound output is normally performed. That is, the operation restriction (such as video block and sound muting) imposed in step S2 is released (step S7). At the same time, the first unlock flag stored in the first memory 17 is changed to the “ON” state (step S7).

On the other hand, when the input code is judged not to be equal to the first unlock code (“N” in step S5), the control portion 16 further judges whether or not the input code is equal to the second unlock code (step S6). And when the input code is judged to be equal to the second unlock code (“Y” in step S6), the connection switch portion 12 is switched to the connecting state.

As a result, a broadcast signal is transmitted to the stages succeeding the reception portion 11, and operation such as various kinds of processing of the broadcast signal, video display, and sound output is normally performed. That is, the operation restriction (such as video block and sound muting) imposed by the processing performed in step S2 is released (step S8). At the same time, the second unlock flag stored in the first memory 17 is changed to the “ON” state (step S8).

After the processing of either step S7 or step S8 is performed, the processing of step S1 is performed again. When the input code is judged not to be equal to the second unlock code, either (“N” in step S6), the processing of step S3 is performed again. That is, the aforementioned operation restriction is not released until the first or second unlock code is correctly entered.

When the first or second unlock flag is judged to be ON as a result of the judgment performed in step S1 (“Y” in step S1), the connection switch portion 12 is brought into the connecting state. That is, the aforementioned operation restriction is not performed, and the television broadcast receiver 1 is allowed to perform its normal operation as a television broadcast receiver (step S9). This normal operation is continued to be performed as long as one of the unlock flags is ON (“Y” in step S1) and a main power supply is ON (“N” in step S0).

However, when both of the unlock flags become OFF (“Y” in step S1), the processing of step S2 is performed. Also, when the main power is turned off (“Y” in step S11), for example, through operation of the remote 2, the normal operation is stopped.

The performance of the series of processing described above not only makes it possible to minimize the burden of the operation-check process performed in the manufacturing process of the television broadcast receiver 1 but also provides the television broadcast receiver 1 with an enhanced anti-theft effect.

That is, the operation-check process can be started just by first turning on the main power supply to the television broadcast receiver 1 and then entering the second unlock code. As a result, the operation restriction is released (see step S8), and thus the operation check can be performed. Here, the second unlock code is set as a code common to all the television broadcast receivers 1 manufactured through the same manufacturing process. This makes it possible to save time and trouble of finding correct second unlock codes of all the television broadcast receivers 1, and thus the burden of the operation-check process can be minimized.

Incidentally, in the television broadcast receiver 1, the second unlock flag automatically returns to the OFF state when a given period of time has elapsed after the input of the second unlock code, and the operation restriction is imposed again on the television broadcast receiver 1 (see steps S1 and S2). That is, when the operation restriction is released as a result of the input code being judged to be equal to the second unlock code, a limit is imposed on the length of time for which the operation restriction remains released. This makes it possible to eliminate a process of turning off the second unlock flag again, and in this respect as well, the burden of the operation-check process can be minimized.

Since the second unlock code is common to a great number of television broadcast receivers 1, once it is known to outsiders, the anti-theft effect of the television broadcast receiver 1 may be seriously deteriorated. However, in the television broadcast receiver 1, the second unlock code is composed of a different number of characters from the first unlock code, and at least one of the characters is not a digit. This helps minimize the possibility of the second unlock code of a product becoming known to outsiders as a result of the first unlock code of the product becoming known to outsiders.

In other words, in this embodiment, if the second unlock code were composed of seven digits, it would be comparatively easy for those who know the first unlock code of a product to find out the second unlock code by, for example, performing a brute force search over all seven-digit numbers. In practice, however, since the second unlock code is composed of eight characters including one or more alphabetic character, such a search is impossible.

The second unlock code, which is thus difficult for outsiders to discover, gives the television broadcast receiver 1 a high anti-theft effect. Incidentally, in this embodiment, although the second unlock code is different from the first unlock code in two respects, that is, that the numbers of characters used in the two unlock codes are different from each other and that at least one of the characters used in the second unlock code is an alphabetic character (which is not used in the first unlock code), the second unlock code may be different from the first unlock code in just one of the two respects. Even in that case, in comparison with the case in which the second unlock code is also composed of seven digits, the second unlock code is more difficult to be discovered.

In the television broadcast receiver 1, as described above, in a case in which the second unlock code is entered, a limit is imposed on the length of the time for which the operation restriction remains released. As a result, a person who knows only the second unlock code needs to enter the second unlock code again and again to make the television broadcast receiver 1 continue its normal operation. Thus, since the television broadcast receiver 1 cannot be practically used with the second unlock code alone, even if the second unlock code becomes known to outsiders, an anti-theft effect of some extent can be expected.

In contrast, in a case in which the first unlock code is entered to release the operation restriction, such a limit is not imposed. This helps avoid the inconvenience of requiring a rightful purchaser to enter the code again and again.

Although the operation restriction is achieved by switching the connection switch portion 12 between the connecting and disconnecting states, it may be achieved by any other methods. For example, the operation restriction may be achieved by directly controlling the operation of, for example, the signal processing portion 13.

The range in which the operation restriction is released (the range of the operation to be released from the operation restriction) when the operation restriction is released as a result of the input code being judged to be equal to the first unlock code (step S7) may be different from that when the operation restriction is released as a result of the input code being judged to be equal to the second unlock code (step S8).

For example, the operation restriction may be completely released (in the whole range) in the processing in step S7, and on the other hand, the operation restriction may be released only with respect to a given channel selected in the operation-check process in the processing in step S8. This prevents a person who has illegally obtained a product from freely using the product even if the person uses the second unlock code.

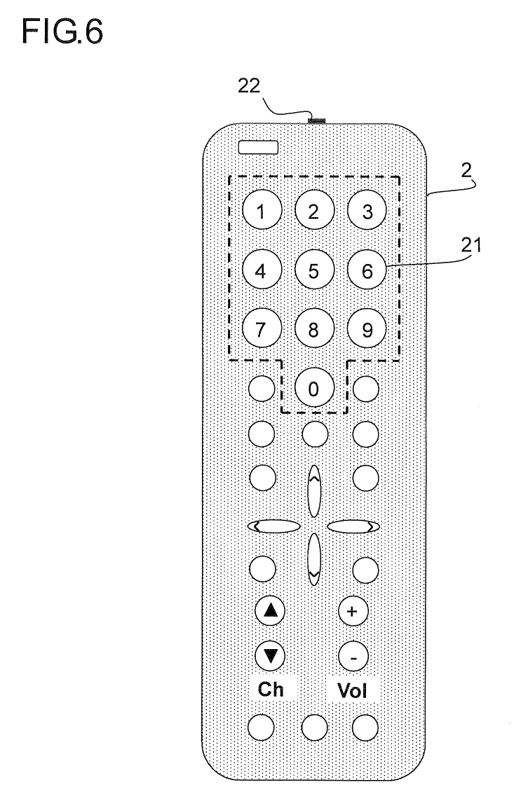

The remote 2 used with the television broadcast receiver 1 may be formed as shown in FIG. 6 as well as in FIG. 3. The remote control 2 shown in FIG. 6 includes, as the push button switch 21 (encircled by a broken line in FIG. 6) for selecting broadcast channels or digits, buttons marked with the digits 0 to 9, respectively. In a case where the remote control 2 as shown in FIG. 6 is used, in entering the characters of the input code described above (from step S3 to step S4), when any of the buttons marked with the digits 0 to 9, respectively, is pressed, a digit corresponding to the pressed button is entered.

As hitherto described, the television broadcast receiver 1 of this embodiment is an electronic apparatus that performs operation of applying predetermined processing to a broadcast signal it has received to display video and output sound of a broadcast content (that is, displaying video or outputting sound based on the received broadcast signal). Furthermore, the television broadcast receiver 1 is provided with a restriction function of imposing restriction at least on part of the operation, and includes the first and second memories 17 and 18 (memory portions) that store the first and second unlock codes that are each composed of one or more characters.

Moreover, the television broadcast receiver 1 is provided with an input reception function receiving the input of an input code composed of one or more characters. In addition, the television broadcast receiver 1 is provided with a restriction release function comparing the input code with the first or second unlock code to release the operation restriction when the input code is equal to the first or second unlock code. The first unlock code is composed of seven characters selected solely from the digits 0 to 9 (predetermined category), and the second unlock code is composed of eight (any number other than seven of) characters, at least one of which is an alphabetic character (a character other than the digits 0 to 9).

Thus, according to the television broadcast receiver 1, it is possible to minimize the possibility of the second unlock code becoming known as a result of the number of or the category of the characters of which the first unlock code is formed becoming known. That is, it is possible to minimize the possibility of, for example, a person who knows the number or the category of characters used in the first unlock code discovering the second unlock code by a method such as a brute force search or successfully guess the second unlock code.

It should be understood that the embodiments specifically described above are not meant to limit the present invention, and that the present invention can be practiced in various other embodiments within the spirit of the present invention. The present invention is applicable to various kinds of electronic apparatuses without being limited to television broadcast receivers.

According to the electronic apparatus of the present invention, the second unlock code is a code composed of other than “m” characters or a code composed of characters at least one of which does not belong to the predetermined category (the category to which the characters of the first unlock code belong). This helps minimize the occurrence of a situation in which, when one (first unlock code) unlock code becomes known, the other unlock code (second unlock code) also becomes known.

Thus, the present invention makes it possible to minimize the possibility of, for example, a person who knows the number or the category of characters used in the first unlock code discovering the second unlock code by a method such as a brute force search or successfully guessing the second unlock code.

What is claimed is:

1. An electronic apparatus performing predetermined operation, comprising:
a restriction portion restricting at least part of the predetermined operation;
a memory portion storing a first unlock code and a second unlock code that are each composed of one or more characters;
an input reception portion receiving input of an input code that is composed of one or more characters; and
a restriction release portion comparing the input code with the first or second unlock code, and releasing the restriction when the input code is equal to the first or second unlock code,
wherein
the first unlock code is composed of “m” (“m” is a natural number) of characters all of which belong to a predetermined category; and
the second unlock code is composed of other than “m” of characters, or of characters at least one of which does not belong to the predetermined category.

2. The electronic apparatus of claim 1,
wherein
a range in which or a length of a period during which the restriction remains released differs according to whether the restriction is released as a result of the input code being judged to be equal to the first unlock code or as a result of the input code being judged to be equal to the second unlock code.

3. The electronic apparatus of claim 2,
wherein
a limit is placed on the length of the period during which the restriction remains released in a case in which the restriction is released because the input code is equal to the second unlock code; and
the limit is not placed on the length of the period during which the restriction remains released in a case in which the restriction is released because the input code is equal to the first unlock code.

4. The electronic apparatus of claim 3,
wherein
the electronic apparatus is one of a plurality of electronic apparatuses that undergo a same operation-check process;
the first unlock code is uniquely set one for each of the plurality of electronic apparatuses; and
the second unlock code is set as an unlock code common to all the plurality of electronic apparatuses.

5. The electronic apparatus of claim 1,
wherein
the second unlock code is composed of other than “m” characters; and
the input reception portion, in receiving the input, invites input of “m” characters.

6. The electronic apparatus of claim 4, further comprising: a memory that is electrically non-rewritable,
wherein the memory stores the second unlock code.

7. The electronic apparatus of claim 1, wherein
the electronic apparatus is a television broadcast receiver receiving a television broadcast signal; and
the predetermined operation is video display operation or sound output operation based on the television broadcast signal that has been received.

8. The electronic apparatus of claim 2, wherein
the electronic apparatus is a television broadcast receiver receiving a television broadcast signal; and
the predetermined operation is video display operation or sound output operation based on the television broadcast signal that has been received.

9. The electronic apparatus of claim 3, wherein
the electronic apparatus is a television broadcast receiver receiving a television broadcast signal; and
the predetermined operation is video display operation or sound output operation based on the television broadcast signal that has been received.

10. The electronic apparatus of claim 4, wherein
the electronic apparatus is a television broadcast receiver receiving a television broadcast signal; and
the predetermined operation is video display operation or sound output operation based on the television broadcast signal that has been received.

11. The electronic apparatus of claim 5, wherein
the electronic apparatus is a television broadcast receiver receiving a television broadcast signal; and
the predetermined operation is video display operation or sound output operation based on the television broadcast signal that has been received.

12. The electronic apparatus of claim 6, wherein
the electronic apparatus is a television broadcast receiver receiving a television broadcast signal; and
the predetermined operation is video display operation or sound output operation based on the television broadcast signal that has been received.
